(19) United States
(12) Patent Application Publication
(10) Pub. No.: US 2007/0132750 A1
(43) Pub. Date: Jun. 14, 2007

(54) SYSTEM AND METHOD FOR CONTROLLING DISPLAY DEVICE BRIGHTNESS

(75) Inventors: Chi-Chou Cheng, Shenzhen (CN); Wen-Chen Tang, Shenzhen (CN); Yu-Hui Huang, Shenzhen (CN); Chung-Hsien Lee, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,526

(22) Filed: Aug. 17, 2006

(30) Foreign Application Priority Data
Dec. 8, 2005 (CN) 200510102332.1

(51) Int. Cl. G09G 5/00

(52) U.S. Cl. 345/207

(57) ABSTRACT

A brightness controlling system includes a sensor, an input device, a display device and a control circuit. The sensor is used for detecting a current ambient illumination level. The input device is used for inputting brightness adjusting commands. The control circuit is used for receiving the brightness adjusting commands and sending control signals to the display device to adjust a current brightness value based on the brightness adjusting commands, and updating relationships between ambient illumination levels and brightness values according to the brightness adjusting commands. A related brightness controlling method and a storage medium recorded with an application program to accomplish the brightness controlling method are also provided.

### FIELD OF THE INVENTION

The present invention generally relates to systems and methods for controlling display devices brightness and, more particularly, to a brightness controlling system and method for automatically adjusting the brightness of a display device.

### DESCRIPTION OF RELATED ART

Display devices, such as cathode ray tube (CRT) monitors and liquid crystal display (LCD) screens, are wildly used in people's everyday life. The display devices are used in computers, mobile phones, and other electronic apparatuses to display text or graphic information.

Display devices, especially those used in portable electronic apparatuses, such as notebook computers, are usually taken to various locations. Ambient illuminations of the locations may be different. If the display devices maintain a constant brightness regardless of the ambient illuminations change, the brightness may not be suitable to the ambient illuminations. This will make viewers feel uncomfortable.

Traditionally, special functional keys are provided on the display devices for adjusting the brightness of the display device according to viewing comfortableness and the ambient illuminations thereof. However, manual adjustment is not convenient and, particularly substantially impossible to follow the change of ambient illuminations. Thus it is desirable to change the brightness of the display device automatically according to the ambient illuminations.

Therefore, automatic adjustments of the brightness of the display devices based on the ambient illuminations have been introduced. A sensor is provided in the display device for detecting a current ambient illumination level and for generating electronic signals based on the current ambient illumination level. The electronic signals are used to change a current brightness value of the display device, so as to conform to the current ambient illumination level.

However, the above mentioned automatic adjustments of the brightness cannot truly satisfy different viewers' requirements because of different viewers comfortableness. That is, at a given ambient illumination level, a viewer A may prefer a relatively high brightness, while a viewer B may prefer a relatively low brightness. However, the sensor generates only one kind of electronic signal dependant on the specific ambient illumination level. Therefore, only one fixed brightness value can be provided according to the fixed relationships between the brightness values and the ambient illumination levels.

Therefore, an improved system and method for adjusting the brightness of a display device is desired.

### SUMMARY OF THE INVENTION

A brightness controlling system includes a sensor, an input device, a display device and a control circuit. The sensor is used for detecting a current ambient illumination level. The input device is used for inputting brightness adjusting commands. The control circuit is used for receiving the brightness adjusting commands and sending control signals to the display device to adjust a current brightness value based on the brightness adjusting commands, and updating relationships between ambient illumination levels and brightness values according to the brightness adjusting commands.

A brightness controlling method for controlling brightness of a display device includes steps of: detecting a current ambient illumination level; determining whether a command is inputted for changing current brightness of the display device; changing the current brightness of the display device based on the command if the command is inputted; and updating relationships between brightness values and ambient illumination levels.

A storage medium is provided for recording an application program. The application program has a computer executable the steps of: detecting a current ambient illumination level; determining whether a command is inputted for changing current brightness of the display device; changing the current brightness of the display device based on the command if the command is inputted; and updating relationships between brightness values and ambient illumination levels.

Other advantages and novel features will become more apparent from the following detailed description of preferred embodiments when taken in conjunction with the accompanying drawings, in which:

### BRIEF DESCRIPTION OF THE DRAWINGS

Many aspects of the brightness controlling system and the brightness controlling method thereof can be better understood with reference to the following drawings. The components in the drawings are not necessarily to scale, the emphasis instead being placed upon clearly illustrating the principles of the present device. Moreover, in the drawings, like reference numerals designate corresponding parts throughout the several views.

FIG. 1 is a block diagram of a brightness controlling system in accordance with an exemplary embodiment; and

FIG. 2 is a flow chart illustrating a brightness controlling procedure of a brightness controlling method in accordance with an exemplary embodiment.

### DETAILED DESCRIPTION OF THE INVENTION

Reference will now be made to the drawings to describe the preferred embodiment of the present brightness controlling system, in detail.

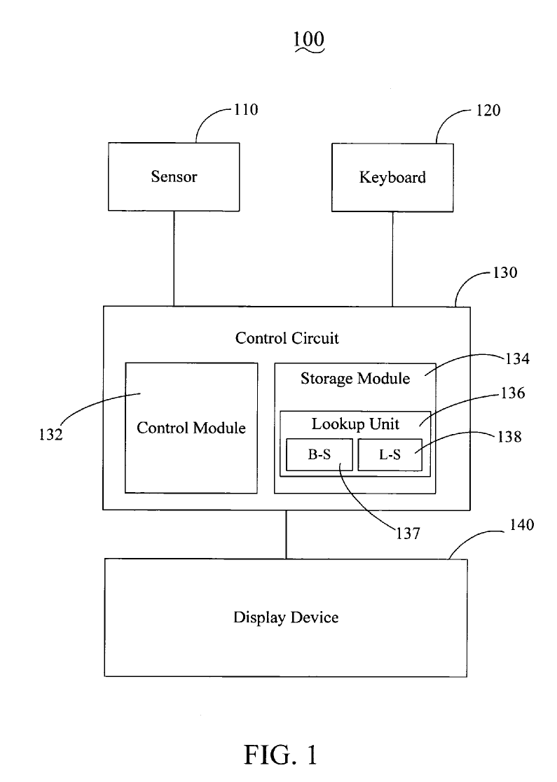

Referring to FIG. 1, a block diagram of a brightness controlling system 100 in accordance with an exemplary embodiment is illustrated. The brightness controlling system 100 includes a sensor 110, a keyboard 120, a control circuit 130, and a display device 140.

The sensor 110 is a photosensitive element (e.g., a photoresistor, a photodiode, or a phototransistor) and is coupled to the control circuit 130 for generating electronic signals based on ambient illumination levels. The electronic signals are transmitted to the control circuit 130 to indicate a current ambient illumination level.

The keyboard 120 is coupled to the control circuit 130 for inputting commands to the control circuit 130. The control circuit 130 adjusts the brightness of the display device 140 according to the commands.

The control circuit 130 includes a control module 132 and a storage module 134. The control module 132 receives the electronic signals generated by the sensor 110 and the commands inputted by the keyboard 120, and then adjusts the brightness of the display device 140 accordingly. The storage module 134 stores a lookup unit 136 that records relationships between the ambient illumination levels and brightness values of the display device 140.

The lookup unit 136 includes a brightness-to-step (B-S) table 137 and a level-to-step (L-S) table 138. The B-S table 137 defines constant relationships between the brightness values and step values. There is a plurality of different brightness values in the B-S table 137, each brightness value corresponding to a respective step value.

The L-S table 138 defines relationships between the ambient illumination levels and step values. Each ambient illumination level corresponds to a respective step value. The step values in the L-S table 138 are replaceable according to the commands inputted by the keyboard 120.

The step values are employed to associate the brightness values and the ambient illumination levels in the brightness controlling system 100. For example, the sensor 110 generates an electronic signal representing a current ambient illumination level. The electronic signal is then fed to the control module 132. A corresponding step value is obtained in the L-S table 138 according to the electronic signal. A corresponding brightness value is then obtained after being searched from the B-S table 137 according to the corresponding step value. Thus the brightness of the display device 140 can be adjusted automatically according to the current ambient illumination level.

Viewers can reset current brightness of the display device 140 according to their own comfortableness. The step value corresponding to the current ambient level in the L-S table 138 can be modified to another step value defined in the B-S table 137. Thus relationships between the ambient illumination levels and the brightness values are adjustable in the lookup unit 136.

An exemplary B-S table 137 is shown as follows:

| Brightness Value | Step Value |
|---|---|
| B00 | S0 |
| B11 | S1 |
| B22 | S2 |
| B33 | S3 |
| B44 | S4 |
| . . . | . . . |
| BFF | S15 |

An exemplary L-S table 138 is shown as follows:

| Illumination Level | Step Value |
|---|---|
| L0 | S3 |
| L1 | S5 |
| L2 | S11 |
| L3 | S15 |

Preferred embodiments will be described with reference to the B-S table 137 and the L-S table 138. For example, the ambient illumination level is L0 according to the electronic signals generated by the sensor 110. The step value corresponding to the ambient illumination level L0 is S3 according to the L-S table 138. The brightness value B33 is then obtained from the B-S table 137, and current brightness of the display device 140 is adjusted according to the brightness value B33.

If a current brightness value, such as B33, doesn't meet a viewer's comfortableness at the current ambient illumination level, such as L0, the viewer can modify the current brightness value via the keyboard 120 to another brightness value defined in the B-S table 137, such as B22. The control module 132 updates the relationships between the illumination levels and the brightness values in the lookup unit 136 based on the viewer's input. The step value S2, which corresponds to the brightness value B22, replaces the step value S3 in the L-S table 138. Then the L-S table 138 is updated as follows:

| Illumination Level | Step Value |
|---|---|
| L0 | S2 |
| L1 | S5 |
| L2 | S11 |
| L3 | S15 |

When the ambient illumination level detected by the sensor 110 is L0, the step value corresponding to the illumination level L0 is S2 according to the updated L-S table 138. The control module 130 adjusts the current brightness of the display device 140 according to the brightness value B22. Thus, the current brightness of the display device 140 meets the viewer's comfortableness.

Exemplarily, a predetermined key (not shown) can be employed to turn on/off the sensor 110 so as to turn on/off the brightness controlling system 100. A delay circuit (not shown) can be introduced to the brightness controlling system 100 for setting the brightness adjusting time intervals.

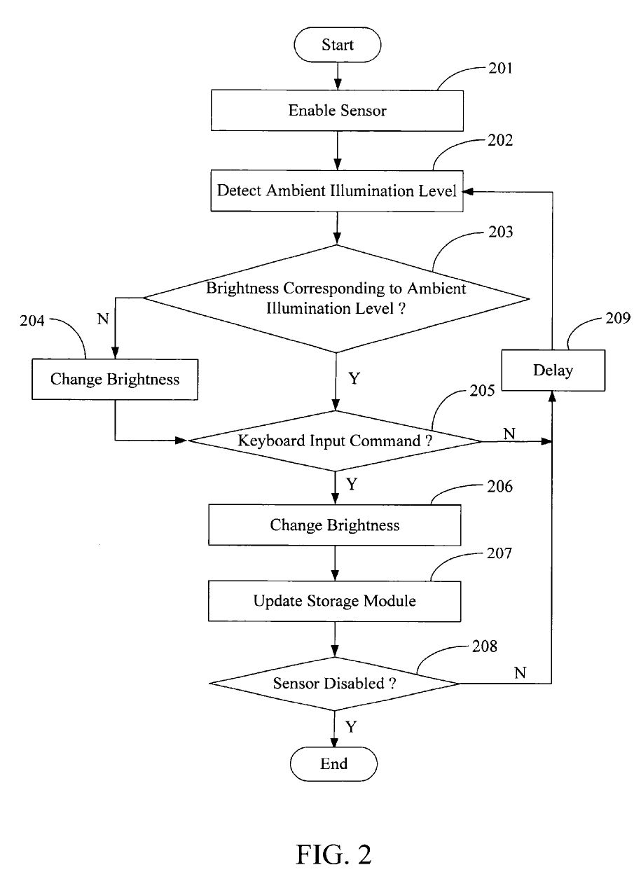

Referring also to FIG. 2, an exemplary brightness controlling procedure of a brightness controlling method is illustrated. First, in step 201, the sensor 110 is enabled. There are many ways to enable the sensor 110, such as pressing the predetermined key or using other input devices to input enabling commands.

Then in step 202, the sensor 110 detects the ambient illumination and generates electronic signals representing a current ambient illumination level.

In step 203, a determination is made as to whether the current brightness value of the display device 140 corresponds to the current ambient illumination level. If so, the procedure then proceeds to step 205.

If in step 203, it is determined that the current brightness value of the display device 140 doesn't corresponds to the current ambient illumination level, the control module 130 changes the current brightness value accordingly so as to match the current ambient illumination level (step 204).

In step 205, The control module 130 concludes whether there is a command inputted via the keyboard 120 to change the current brightness of the display device 140. If no commands are inputted via the keyboard 120 to change the brightness, the procedure delays a period of predetermined time (step 209) and loops back to step 202. If there is a command inputted via the keyboard 120 to change the current brightness, the control module 132 changes the current brightness value according to the command inputted via the keyboard (step 206).

Successively, in step 207, the control module 132 updates the L-S table 138 of the brightness controlling system 100 by changing the step value that corresponds to the current ambient illumination level in the L-S table 138 to another step value which corresponds to the adjusted brightness value of the B-S table 137.

In step 208, A determination is made as to whether the sensor 110 is disabled. If so, the procedure is terminated. If the sensor 110 is not disabled, the procedure delays a period of predetermined time (step 209) and loops back to step 202.

When a viewer inputs commands to change the brightness of the display device 140 corresponding to a specific ambient illumination level, the step value will be updated according to the viewer's input. Thus relationships between the ambient illumination levels and the brightness values are customizable because of an updateable step value.

The depicted embodiment in FIG. 1 and the above-described procedure are not meant to imply architectural limitations. It should be noted that the described system is exemplary, and that FIG. 1 could include any other input devices besides the keyboard 120, such as, for example, a mouse, predetermined keys set on the display device 140, touch pad, and the like. It is easy to be understood that the control circuit 130 can be many kinds of controllers or chipsets, such as, but not limited to, an embedded controller, a display controller, a general processor, a graphic processing unit (GPU) or multiple chipsets. The storage module 134 may be a flash memory integrated in the controllers or an independent memory for storing the lookup unit 136 and other program instructions.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A brightness controlling system, comprising:
a sensor for detecting a current ambient illumination level;
an input device for inputting brightness adjusting commands;
a display device;
a control circuit for receiving the brightness adjusting commands and sending control signals to the display device to adjust a current brightness value based on the brightness adjusting commands, and updating relationships between ambient illumination levels and brightness values according to the brightness adjusting commands.

2. The brightness controlling system as claimed in claim 1, wherein the control circuit comprises a storage module for storing the ambient illumination levels and the brightness values, each ambient illumination level corresponding to a brightness value.

3. The brightness controlling system as claimed in claim 2, wherein the storage module comprises a lookup unit for storing a brightness-to-step table that stores relationships between brightness values and step values, each brightness value corresponding to a step value.

4. The brightness controlling system as claimed in claim 3, wherein the lookup unit comprises a level-to-step table for storing relationships between ambient illumination levels and the step values, each ambient illumination level corresponding to a step value.

5. The brightness controlling system as claimed in claim 4, wherein each step value in the level-to-step table is replaceable with other step values included in the brightness-to-step table according to the brightness adjusting commands, while the brightness-to-step table remains constant.

6. The brightness controlling system as claimed in claim 5, wherein the control circuit replaces a step value corresponding to the current ambient illumination level in the level-to-step table with another step value corresponding to the changed brightness value in the brightness-to-step table.

7. The brightness controlling system as claimed in claim 1, wherein the control circuit is an embedded controller.

8. The brightness controlling system as claimed in claim 7, wherein the storage module is a flash memory integrated in the embedded controller.

9. The brightness controlling system as claimed in claim 1, wherein the sensor generates electronic signals representing the current ambient illumination level.

10. The brightness controlling system as claimed in claim 9, wherein the control circuit sends the control signals to adjust the current brightness value according to the electronic signals if the current brightness value does not correspond to the current ambient illumination level.

11. The brightness controlling system as claimed in claim 1, wherein the control circuit comprises a control module for receiving the brightness adjusting commands and sending the control signals to the display device to adjust the current brightness values based on the brightness adjusting commands.

12. A brightness controlling method for controlling brightness of a display device, comprising:
detecting a current ambient illumination level;
determining whether a command is inputted for changing current brightness of the display device; adjusting the current brightness of the display device based on the command if the command is inputted; and
updating relationships between brightness values and ambient illumination levels.

13. The brightness controlling method as claimed in claim 12, further comprising steps of:
generating electronic signals representing the current ambient illumination level; and
adjusting the current brightness value of the display device based on the electronic signals.

14. The brightness controlling method as claimed in claim 12, further comprising steps of:
determining whether a sensor is disabled; and
if the sensor is not disabled, delaying a period of predetermined time and loops back to the step of detecting.

15. The brightness controlling method as claimed in claim 12, wherein the relationships between the brightness values of the display device and the ambient illumination levels are stored in a storage module.

16. The brightness controlling method as claimed in claim 12, wherein the relationships between the brightness values and the ambient illumination levels include relationships between brightness values and step values, each step value corresponding to a brightness value, the relationships between brightness values and step values are defined in a brightness-to-step table.

17. The brightness controlling method as claimed in claim 16, wherein the relationships between the brightness values and the ambient illumination levels further include relationships between ambient illumination levels and step values, each ambient illumination level corresponding to a modifiable step value, the relationships between ambient illumination levels and step values are defined in a level-to-step table.

18. The brightness controlling method as claimed in claim 17, wherein the step of updating is performed by replacing a step value corresponding to the current ambient illumination level in the level-to-step table with another step value corresponding to the changed brightness value in the brightness-to-step table.

19. A storage medium recorded with an application program, the application program having a computer executable steps of:
detecting a current ambient illumination level;
determining whether a command is inputted for changing current brightness of the display device;
changing the current brightness of the display device based on the command if the command is inputted; and
updating relationships between brightness values and ambient illumination levels.

20. The storage medium as claimed in claim 19, wherein the application program further having a computer executable steps of:
generating electronic signals representing the current ambient illumination level; and
adjusting the current brightness value of the display device based on the electronic signals.
